(19) United States
(12) Patent Application Publication
(10) Pub. No.: US 2004/0103958 A1
(43) Pub. Date: Jun. 3, 2004

(54) ECCENTRIC DISC DEBARKER

(76) Inventors: Victor PEETSO, Kelowna (CA); Alister HUME, Surrey (CA)

Correspondence Address: EDWARD YOO C/O BENNETT JONES, 1000 ATCO CENTRE, 10035 - 105 STREET, EDMONTON, ALBERTA, AB, T5J3T2, CA

(21) Appl. No.: 10/604,493

(22) Filed: Jul. 25, 2003

Related U.S. Application Data
(60) Provisional application No. 60/319,427, filed on Jul. 25, 2002.

(51) Int. Cl. B27L 1/00; B27C 1/00; B27C 5/00; B27G 13/00

(52) U.S. Cl. 144/218; 144/208.9

(57) ABSTRACT

A debarking apparatus comprises eccentric debarking discs having a non-circular perimeter shape.

### CROSS REFERENCE TO RELATED APPLICATIONS

The present application claims the priority of U.S. Provisional Patent Application No. 60/319,427 filed on Jul. 25, 2002, the contents of which are incorporated herein by reference.

### BACKGROUND OF INVENTION

The present invention relates to an eccentric multi-lobed debarking disc.

Log debarking apparatuses are known which use debarking discs arrayed on a rotating shaft. An example of such an apparatus is disclosed in co-owned U.S. Pat. No. 5,394,912 and Applicant's co-pending U.S. patent application Ser. No. 10/248,857 filed Feb. 25, 2003. Conventional debarking disks are circular and equipped with projections arrayed on the circumference of the disk which act as abrading elements.

### SUMMARY OF INVENTION

The present invention relates to an eccentric multi-lobed debarking disc. In one aspect, the invention comprises a debarking disc comprising a rotating member having an eccentric perimeter shape. In one embodiment, the disc comprises a symmetrical multi-lobed disc having a central rotation point.

In another aspect, the invention comprises debarking apparatuses comprising the eccentric debarking discs described and claimed herein.

### BRIEF DESCRIPTION OF DRAWINGS

The invention will now be described by way of an exemplary embodiment with reference to the accompanying simplified, diagrammatic, not-to-scale drawings.

FIG. 1 depicts of one embodiment of the present invention mounted in a debarking apparatus.

FIG. 2 depicts an alternative embodiment.

FIG. 3 depicts a non-overlapping spacing configuration.

FIG. 4 depicts an alternative embodiment of a disc mounted in a debarking apparatus.

### DETAILED DESCRIPTION

The present invention provides for a debarking apparatus using discs mounted on a rotating shaft. When describing the present invention, all terms not defined herein have their common art-recognized meanings.

In general terms, debarking disc of the present invention comprises a rotating member having an eccentric perimeter shape comprising at least one lobe. The disc may or may not be symmetrical. The disc may rotate about a central rotation point, or the disc may have an offset rotational point. The perimeter may be continuous or discontinuous.

The debarking apparatus of the present invention comprise a bin (1) designed to contain logs and an array of debarking rotors (2) arrayed along a bottom portion of the bin. The discs (10) are mounted to the rotors (2) along the length of the rotor shaft (14). The shafts may be placed substantially horizontally or on a slight inclined plane. Debarking apparatuses of this type are further described in co-owned and co-pending application U.S. Ser. No. 10/248,857 filed Feb. 25, 2003, the contents of which are incorporated herein by reference. The discs described in that application are circular with abrader teeth mounted around the circumference of the disc.

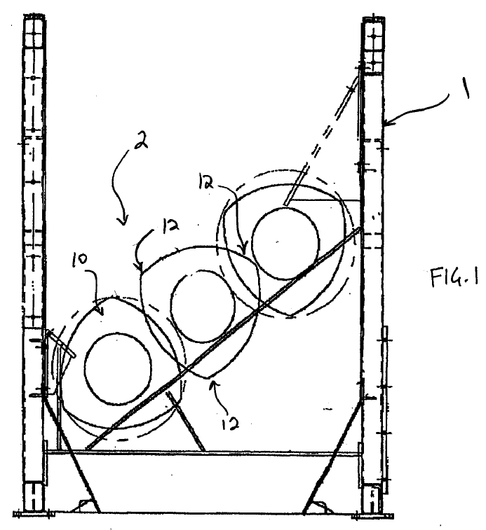

As shown in FIG. 1, an exemplary embodiment of an eccentric debarking disc (10) having three lobes (12) is shown interleaved with debarking discs arrayed on adjacent and parallel rotating shafts (14). Each disc (10) is formed from a flat plate and has an eccentric shape which is not circular, but may or may not be symmetrical about one or more axes. The perimeter of the disc may include convex, concave, compound or straight line portions between the lobes. The lobes may be pointy or may be rounded.

A preferred embodiment has three lobes, as illustrated in FIG. 1, although the scope of the invention may include two, three, four or more lobes. The tri lobed disc (10) shown has 3 axes of symmettry.

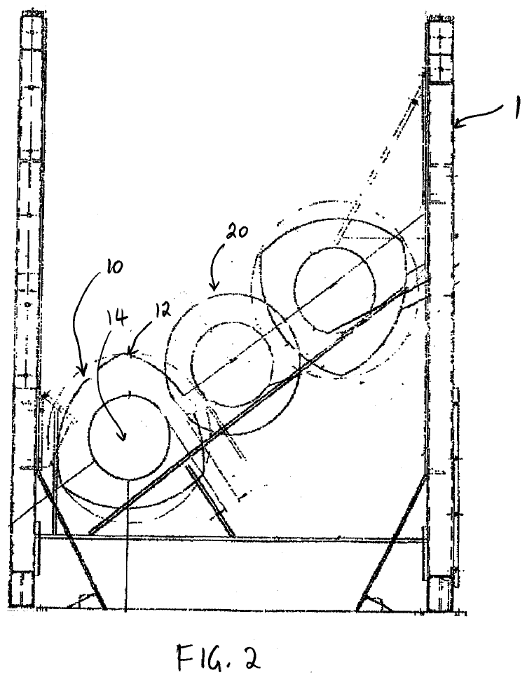

As shown in FIG. 2, the eccentric discs of the present invention (10) may be used in conjunction with circular filler discs (20).

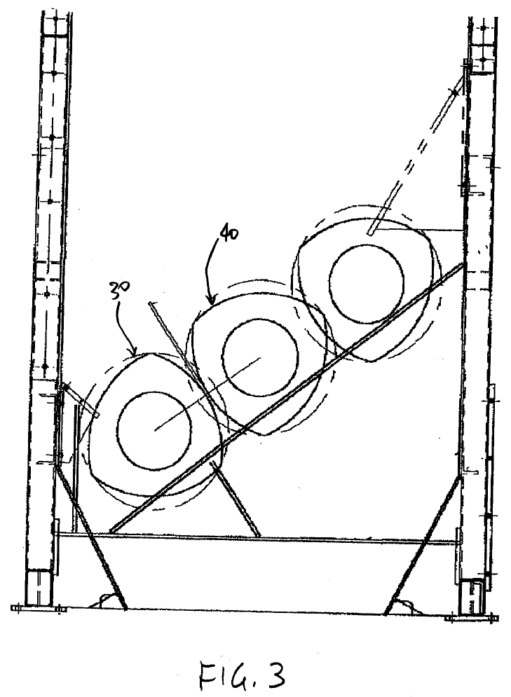

The lateral spacing between the adjacent shafts may be varied. In one embodiment, the shafts are spaced apart such that there is no overlap between adjacent discs when the disc lobes are not directed at the adjacent disc, as shown by discs (30) and (40) in FIG. 3. In other words, the overlap between adjacent discs does not extend as far as the shortest distance between the axis of rotation and the disc periphery.

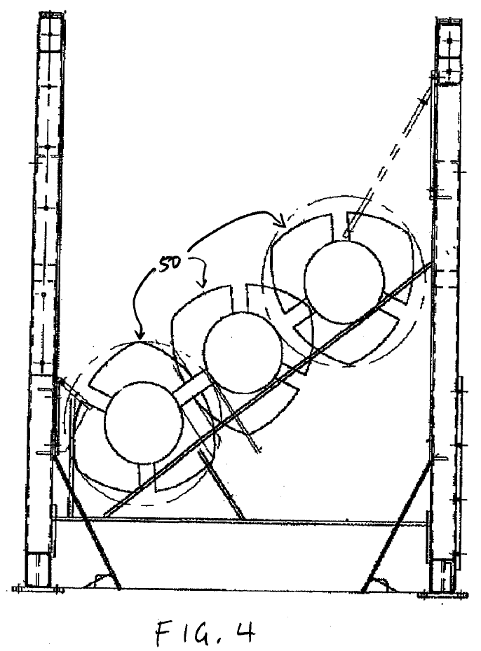

In an alternative embodiment, the discs (50) may have discontinuous perimeters but retain the basic eccentric, multi-lobed shape. In FIG. 4, tri-lobed discontinous discs (50) are shown, which are within the scope of the present invention.

Each disc may optionally have abrader teeth (not shown) placed about the perimeter which may be fixed or replaceable.

The eccentric discs (10) impart a lifting, rolling, pushing and scrubbing action to wood fibre within the debarking apparatus which provides an effective debarking action without destroying or damaging the wood fibre. The discs may be arrayed aligned with the discs on adjacent shafts (12) or may be arrayed in helical, interleaved or a random pattern.

As will be apparent to those skilled in the art, various modifications, adaptations and variations of the foregoing specific disclosure can be made without departing from the scope of the invention claimed herein. The various features and elements of the described invention may be combined in a manner different from the combinations described or claimed herein, without departing from the scope of the invention.

1. An eccentric debarking disc comprising a flat element having a non-circular perimeter shape having at least one lobe.

2. The disc of claim 1 having 3 lobes.

3. The disc of claim 2 having at least one line of symmetry.

4. The disc of claim 3 having 3 lines of symmetry.

3. The disc of claim 2 having a discontinuous peripheral outline.

4. A debarking apparatus comprising an eccentric debarking disc as claimed in claim 1.

5. The debarking apparatus of claim 4 further comprising substantially circular filler disc.
